(19) United States
(12) Patent Application Publication
(10) Pub. No.: US 2010/0109968 A1
(43) Pub. Date: May 6, 2010

(54) ANTENNA DEVICE AND PORTABLE TERMINAL DEVICE

(75) Inventors: Hidenori Suzuki, Miyagi (JP); Kazutaka Iwase, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/593,408

(22) PCT Filed: Mar. 29, 2007
(86) PCT No.: PCT/JP2007/056980

§ 371 Date: Sep. 28, 2009

(51) Int. Cl. H01Q 3/24; H01Q 1/36

(52) U.S. Cl. 343/876; 343/895

(57) ABSTRACT

An antenna device and a portable terminal device are provided that can be used for radio communication systems having different frequency bands by sharing a single antenna. An antenna device has a spiral antenna 21 formed in a spiral shape; a first feeding part 241 connected to and feeding an electric power to a first radio system operating in a first frequency band; and a second feeding part 242 connected to and feeding an electric power to a second radio system operating in a second frequency band. The antenna device includes: a feeding part switch unit 24 that switches a connecting state of the first feeding part 241 or the second feeding part 242 and an outermost periphery or an inner periphery inside the outermost periphery of the spiral antenna 21, and a grounding switch unit 23 that switches a prescribed point of the outermost periphery of the spiral antenna 21 to either an opening or a grounding. The spiral antenna 21 is formed in such a way that the width of a conductor forming the spiral antenna is different in its dimension between the outermost periphery and the inner periphery inside the outermost periphery.

### TECHNICAL FIELD

The present invention relates to an antenna device preferably suitable for a miniaturization that can share an antenna between communication systems having different frequency bands and a portable terminal device provided with the antenna device.

### BACKGROUND ART

In recent years, as a portable terminal device for reading information written in a card or writing information in the card, a reader and writer is proposed that can read and write, for instance, a non-contact IC card or an RF tag (For instance, see patent literature 1).

Namely, in the reader and writer, for instance, as shown in FIG. 24, the portable terminal device 100 includes a reader and writer part 101 that reads electronic information of the non-contact IC card or a non-contact IC tag (refer them together to as an RFID) 200 through an antenna 105, a memory part 102 that holds the electronic information of the RFID 200 read by the reader and writer part 101 and a charging control part 104 that controls the charging of a battery 103. In the reader and writer, when the battery 103 is charged, an electric signal inputted from a coil electromagnetically connected to a charging power supply device 300 to form the antenna 105 is allowed to be inputted to the charging control part 104. Patent literature 1: JP-A-2001-307032

### DISCLOSURE OF THE INVENTION

### Problems that the Invention is to Solve

As an object on which the electronic information is read and written by the above-described reader and writer, the RFID (for instance, 950 MHz) or the like is exemplified that carries out a radio communication in a frequency band near a frequency band used mainly by a portable telephone. Further, in recent years, as one kind of the non-contact IC card, for instance, a non-contact communication system that carries out a communication in a frequency band greatly lower than the frequency band used in the portable telephone has been developed and started to be used.

However, such a reader and writer does not structurally meet a process for reading, for instance, a non-contact IC card of a different communication system depending on a low frequency band such as FeliCa (a registered trademark) of 13.56 MHz by one antenna. (Felica is a non-contact IC card technical system in which Sony Corporation developed).

Therefore, for the communication system of the different frequency band, since an exclusive antenna device meeting the above-described communication system needs to be separately provided, the reader and writer part is enlarged. Thus, the reader and writer is not convenient as a portable and compact device.

The present invention is devised by considering the above-described circumstances and it is an object of the present invention to provide an antenna device that can be used for radio communication systems having different frequency bands by sharing a single antenna, and accordingly, is suitable for a miniaturization and a portable terminal device provided with the antenna device.

### Means for Solving the Problems

Namely, in an antenna device of the present invention having: a spiral antenna formed in a spiral shape; a first feeding part connected to and feeding an electric power to a first radio system operating in a first frequency band; and a second feeding part connected to and feeding an electric power to a second radio system operating in a second frequency band, the antenna device includes: a feeding part switch unit that switches a connecting state of the first feeding part or the second feeding part and an outermost periphery or an inner periphery inside the outermost periphery of the spiral antenna, and a grounding switch unit that switches a prescribed point of the outermost periphery of the spiral antenna t& either an opening or a grounding. The spiral antenna is formed in such a way that the width of a conductor forming the spiral antenna is different in its dimension between the outermost periphery and the inner periphery inside the outermost periphery.

An antenna device of the present invention may be formed in such a way that the feeding part switch unit is formed with a first switch selectively connecting the first feeding part or the second feeding part to a starting point of the outermost periphery of the spiral antenna or connects the first feeding part or the second feeding part to an end point of the inner periphery, and the first switch is operated so that the spiral antenna may operate as a spiral loop antenna or a plate shaped antenna using the outer periphery.

An antenna device of the present invention may be formed in such a way that the grounding switch unit is formed with a second switch that may switch the prescribed point of the outermost periphery of the spiral antenna either to an opening or a grounding, and the spiral antenna operates as the plate shaped antenna for a UHF band as a high frequency band or the spiral loop antenna for 13.56 MHz band as a low frequency band.

An antenna device of the present invention may be formed in such a way that the feeding part switch unit has the first switch that selectively connects the starting point of the outermost periphery of the spiral antenna to the first feeding part or the second feeding part and a third switch that selectively switches to connect the starting point of the outermost periphery of the spiral antenna to the end point of the outermost periphery or to open both the starting point and the end point of the outermost periphery of the spiral antenna, and when the starting point of the outermost periphery of the spiral antenna is connected to the radio system for the high frequency band of the first radio system or the second radio system by the first switch, the starting point of the outermost periphery of the spiral antenna is connected to the end point of the outermost periphery by the third switch, on the other hand, when the starting point of the outermost periphery of the spiral antenna is connected to the radio system for the low frequency band of the first radio system or the second radio system by the first switch, the starting point of the outermost periphery of the spiral antenna is opened to the end point of the outermost periphery of the spiral antenna by the third switch.

An antenna device of the present invention may further include: a plate shaped conductor positionally overlapped on an upper part or a lower part of the outermost periphery of the spiral antenna with an insulating layer held between the conductor and the spiral antenna and having one end connected to the end point of the inner periphery of the spiral antenna. The plate shaped conductor may be electro-statically connected to the outermost periphery, and the grounding switch unit and the feeding part switch unit are switched depending on a used communication system so that the spiral loop antenna and the plate shaped antenna using the outermost periphery may be switched.

An antenna device of the present invention may be formed in such a way that the plate shaped conductor is provided on the outermost periphery of the spiral antenna and a part of the inner periphery, the upper part or the lower periphery or both of them under a state the conductor is insulated from them, the outermost periphery of the spiral antenna and the inner periphery may be electro-statically connected to the conductor, and the grounding switch unit and the feeding part switch unit are switched depending on a used communication system so that the spiral loop antenna and the plate shaped antenna using the outermost periphery may be switched.

In an antenna device having: a spiral antenna formed in a spiral shape; and a feeding part that feeds an electric power to the spiral antenna, the spiral antenna is formed with a conductor whose width is different in its dimension between an outermost periphery and an inner periphery inside the outermost periphery. The antenna device includes: a plate shaped metal conductor provided on an upper part or a lower part of the spiral antenna, insulated from them and formed substantially in the shape of a character [symbol] with a center bored; the metal conductor being formed to be electro-statically connected to the spiral antenna, and the outermost periphery of the spiral antenna or the metal conductor being grounded at a prescribed point, and a feeding part switch unit that switched a connecting state between the feeding part and the outermost periphery or the inner periphery of the spiral antenna. The feeding part switch unit is switched depending on a used communication system so that the spiral antenna may be switched as an antenna of different frequency bands.

In an antenna device of the present invention having: a spiral antenna formed in a spiral shape; and a feeding part that feeds an electric power to the spiral antenna, the spiral antenna is formed with a conductor whose width is different in its dimension between an outermost periphery and an inner periphery inside the outermost periphery. The antenna device includes: a plate shaped metal conductor with a central part bored which is provided outside the spiral antenna under a state that the conductor is connected integrally in parallel with the spiral antenna; a grounding switch unit that may switch a prescribed point of the outermost periphery of the spiral antenna to either an opening or a grounding; and a feeding part switch unit that switches a connecting state between the feeding part and the outermost periphery or the inner periphery of the spiral antenna. The feeding part switch unit is switched depending on a used communication system so that the spiral antenna may be switched and used as an antenna of different frequency bands by using the inductance of the inner periphery of the spiral antenna.

A portable terminal device of the present invention is provided with the antenna device described in any one of the above-described items.

### ADVANTAGE OF THE INVENTION

According to the present invention, an antenna device and a portable terminal device may be provided that can be used in radio communication systems in two different kinds of frequency bands by sharing a single antenna.

### BRIEF DESCRIPTION OF THE DRAWINGS

FIG. 1 is a schematic perspective view of a potable terminal device having an antenna device according to the present invention.

FIG. 2 is a schematic structural diagram of an antenna device according to a first embodiment of the present invention.

FIG. 3 is an explanatory view showing a basic structure of an inverted F antenna of the antenna device according to the present invention.

FIG. 4 is an explanatory view showing an operation when the antenna device according to the first embodiment is used as a first radio system.

FIG. 5 is an explanatory view showing an operation when the antenna device according to the first embodiment is used as a second radio system.

FIG. 6 is a schematic structural diagram of an antenna device according to a second embodiment of the present invention.

FIG. 7 is an explanatory view showing an operation when the antenna device according to the second embodiment is used as a first radio system.

FIG. 8 is an explanatory view showing an operation when the antenna device according to the second embodiment is used as a second radio system.

FIG. 9(A) is a schematic structural diagram of an antenna device according to a third embodiment of the present invention and FIG. 9 (B) is a sectional view taken along a line IX-IX of FIG. 9(A).

FIG. 10(A) is an explanatory view showing an operation when the antenna device according to the third embodiment is used as a first radio system and FIG. 10(B) is a sectional view thereof.

FIG. 11(A) is an explanatory view showing an operation when the antenna device according to the third embodiment is used as a second radio system and FIG. 11(B) is a sectional view thereof.

FIG. 12 (A) is a schematic structural diagram of an antenna device according to a fourth embodiment of the present invention and FIG. 12 (B) is a sectional view taken along a line IX-IX of FIG. 12(A).

FIG. 13(A) is an explanatory view showing an operation when the antenna device according to the fourth embodiment is used as a first radio system and FIG. 13(B) is a sectional view thereof.

FIG. 14(A) is an explanatory view showing an operation when the antenna device according to the fourth embodiment is used as a second radio system and FIG. 14(B) is a sectional view thereof.

FIG. 15 (A) is a schematic structural diagram of an antenna device according to a fifth embodiment of the present invention and FIG. 15(B) is a sectional view taken along a line IX-IX of FIG. 15(A).

FIG. 16(A) is an explanatory view showing an operation when the antenna device according to the fifth embodiment is used as a first radio system and FIG. 16(B) is a sectional view thereof.

FIG. 17(A) is an explanatory view showing an operation when the antenna device according to the fifth embodiment is used as a second radio system and FIG. 17(B) is a sectional view thereof.

FIG. 18(A) is a schematic structural diagram of an antenna device according to a sixth embodiment of the present invention and FIG. 18(B) is a sectional view taken along a line IX-IX of FIG. 18(A).

FIG. 19 is a circuit diagram of the antenna device according to the sixth embodiment.

FIG. 20 is an exploded view showing an antenna part of the antenna device according to the sixth embodiment.

FIG. 21(A) is an explanatory view showing an operation when the antenna device according to the sixth embodiment is used as a first radio system and FIG. 21(B) is a sectional view thereof.

FIG. 22(A) is an explanatory view showing an operation when the antenna device according to the sixth embodiment is used as a second radio system and FIG. 22(B) is a sectional view thereof.

FIG. 23 is a schematic structural diagram showing a modified example of the embodiment of the present invention.

FIG. 24 is a block diagram showing a usual antenna device.

### DESCRIPTION OF REFERENCE NUMERALS AND SIGNS>

10 portable telephone (portable terminal device)
11 upper casing
12 lower casing
14 switch for switching
2 to 7 first to sixth antenna device
21 spiral antenna
21A outermost winding part (outermost periphery)
21B inner peripheral winding part (inner periphery)
21C wiring part
21D end conductor part
21A₁ first side part
21A₄ fourth side part
21B inner peripheral winding part
21B₁ outermost side part
212 lead-out line
212 lead-out line
213 lead-out line
22 feeding part switch unit
22B first feeding terminal
22C second feeding terminal
22A switching terminal
23 grounding switch unit
23A switching terminal
23B grounding terminal
23C opening terminal
24 feeding part
241 first feeding part
242 second feeding part
A inverted F antenna
M main part (main body part)
P feeding line
S short-circuit line
SW1 first switch
SW2 second switch
SW3 third switch

### BEST MODE FOR CARRYING OUT THE INVENTION

Now, embodiments of the present invention will be described below in detail by referring to the attached drawings.

### First Embodiment

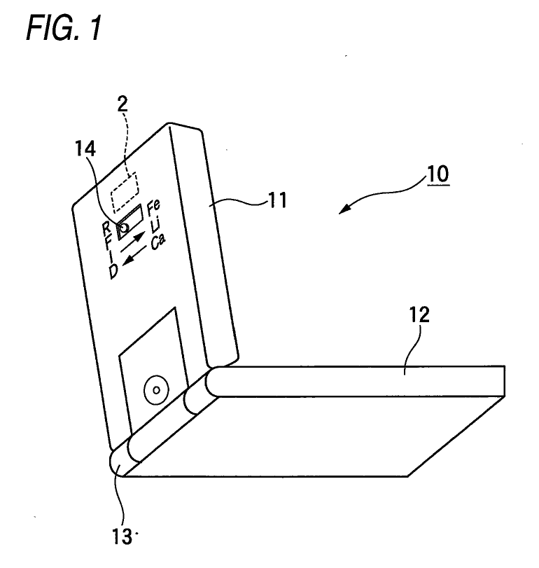

FIG. 1 shows a portable telephone 10 according to a first embodiment of the present invention. The portable telephone 10 includes an upper casing 11 and a lower casing 12 and a hinge part 13 for connecting the casings so as to freely rotate. In the upper casing 11, a first antenna device 2 according to the first embodiment is provided.

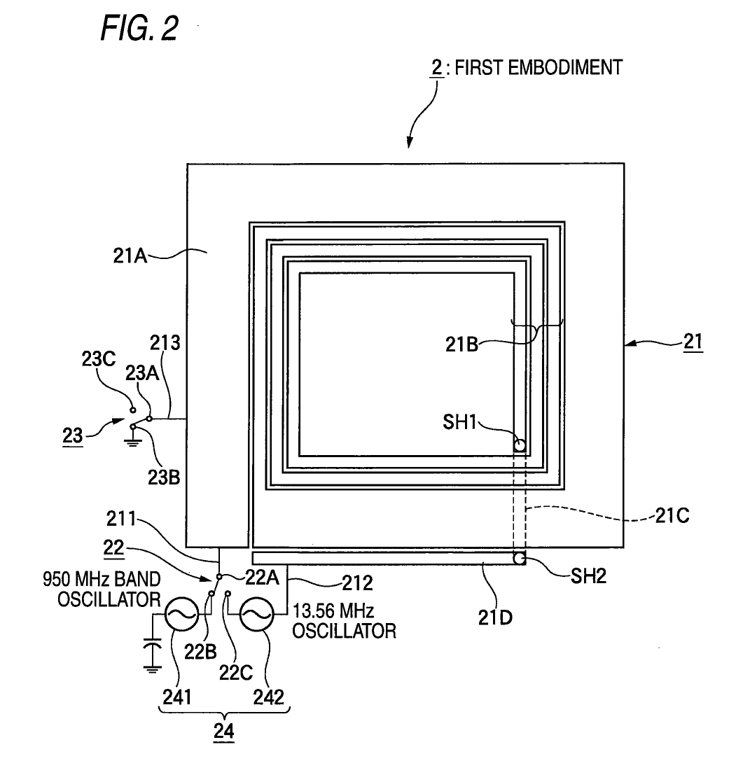

As shown in FIG. 2, the first antenna device 2 includes a spiral antenna 21 formed in a spiral shape, a feeding part switch unit 22 for switching a connection of the spiral antenna 21 and a below-described feeding part 24, a grounding switch unit 23 provided in the outermost periphery of the spiral antenna 21 and the feeding part 24 having first and second feeding parts 241 and 242 and connected to the spiral antenna 21.

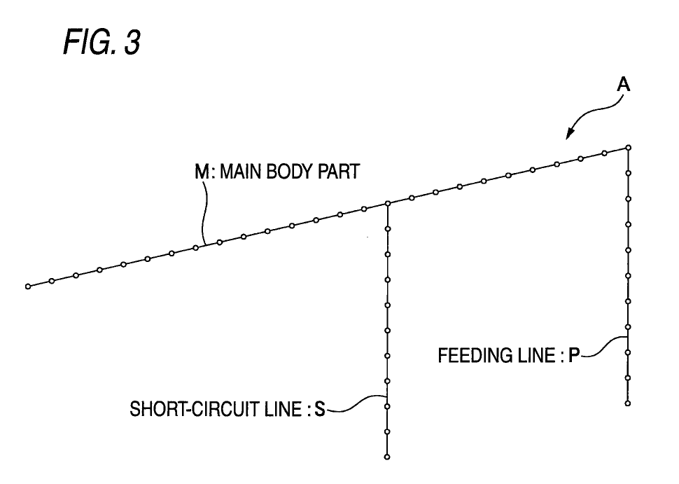

The spiral antenna 21 is formed so as to operate not only as a loop antenna (refer it to as a “spiral loop antenna” hereinafter) using an entire part of the spiral antenna (for a low frequency band), but also as an inverted F antenna A (see FIG. 3) (for a high frequency band) using an outermost peripheral part. Further, the spiral antenna 21 is formed in such a way that the width of a conductor is different in its dimension between a conductor part of an outermost periphery (refer it to as an “outermost winding part 21A”, hereinafter) and a conductor part of an inner periphery (refer it to as an “inner peripheral winding part 21B”, hereinafter). That is, the width of the inner peripheral winding part 21B is narrowed relative to the outermost winding part 21A and spaces between the outermost winding part 21A and peripheral parts of the inner peripheral winding part 21B respectively are narrowed. In such a structure, the wide outermost winding part 21A (that is allowed to meet the high frequency band such as 950 MHz) is formed as a plate shaped antenna (a plate inverted F antenna (PIFA)). The space between the outermost winding part 21A and the inner peripheral winding part 21B is set to a prescribed value so that capacities of wirings between the outermost winding 21A and the inner peripheral winding part 21B are connected together in view of a distribution factor.

Namely, when the spiral antenna 21 is allowed to operate as an antenna for a prescribed high frequency band, the outermost winding part 21A is set to the same potential by the capacities between the wirings of the spiral loop antenna so that the spiral antenna is allowed to function as the inverted F antenna. On the other hand, when the spiral antenna is allowed to operate as an antenna for a low frequency band, since the capacities between the wirings of the spiral loop antenna are small, a current is supplied to ordinary wirings physically connected together. Thus, the spiral antenna is allowed to function as a spiral type loop antenna.

Further, in a board which is not shown in the drawing, such as a printed circuit board having a surface on which the spiral antenna 21 is mounted, an innermost part of the inner peripheral winding part 21B is connected to one end of a wiring part 21C provided on the back surface of the board with the same dimension of width as that of the inner peripheral winding part 21B through a through hole SH1. Further, the wiring part 21C is wired in such a manner as to stride over the inner peripheral winding part 21B and the outermost winding part 21A on the surface of the board from the backside of the board. Further, the other end part of the wiring part 21C is connected to one end of an end conductor part 21D having the same dimension of width as that of the inner peripheral winding part 21B provided on the surface of the board through a through hole SH2.

The inverted F antenna A shown in FIG. 3 includes, as well known, a feeding line P connected to the feeding part, a short-circuit line S that is grounded and a main part M (refer it to as a “main body part”, herein after) to which the feeding line P and the short-circuit line S are connected.

The feeding part switch unit 22 is allowed to operate in cooperation with the below-described grounding switch unit 23 so that the spiral antenna 21 may be switched to an operational function as the loop antenna for the low frequency band and an operational function as the inverted F antenna for the high frequency band. The feeding part switch unit 22 of the present embodiment is formed with a first switch SW1 that connects a switching terminal 22A provided in an end part of a lead-out line 211 (the feeding line P) led out or drawn out from a starting point of the outermost winding part 21A to a first feeding terminal 22B having one end connected to the first feeding part 241 or a second feeding terminal 22C provided in a lead-out line 212 (through the second feeding part 242 forming a part of the feeding part 24) from the end conductor part 21D of the inner peripheral winding part 21B side by switching the first feeding terminal 22B and the second feeding terminal 22C.

The grounding switch unit 23 switches the outermost winding part 21A of the spiral antenna 21 either to an opening or a grounding and is formed with a second switch SW2 that connects a switching terminal 23A at one end of a lead-out line 213 (the short-circuit line S) connected to a part a prescribed distance spaced from the starting point of the outermost winding part 21A to a grounding terminal 23B connected to a ground plate not shown in the drawing (GND of a casing side) part or an opening terminal 23C by switching the grounding terminal 23B and the opening terminal 23C. According to this embodiment, in the feeding part switch unit 22 and the grounding switch unit 23, a combined pattern at the time of switching on and off is exclusively determined. Therefore, in the present embodiment, since a user switches a switch 14 (see FIG. 1) for switching on/off to selectively use one of below-described radio communication systems (as well as a function as the portable telephone), the operations of the feeding part switch unit 22 and the grounding switch unit 23 are automatically controlled by a control part not shown in the drawing.

The feeding part 24 includes the first feeding part 241 for the high frequency band and the second feeding part 242 for the low frequency band. The first feeding part 241 of the present embodiment connects and supplies a radio wave of a UHF (high frequency) band (a first frequency band) such as 950 MHz to a non-contact radio communication system (refer it to as a “first radio system”, hereinafter) such as an RFID tag system, and may read an RFID tag even when a communication distance is longer than that of a below-described radio communication system for the low frequency band.

On the other hand, the second feeding part 242 is connected to and supplies an electric power to a radio communication system (refer it to as a “second radio system”, hereinafter) in a short distance such as an IC tag or FeliCa (a registered trademark of Sony Corporation) used in the low frequency band (a second frequency band) such as 13.56 MHz (or 2.45 GHz). The second radio system may meet, for instance, a season ticket, electronic money, a point service and a biological certification used in a management of entry into a room or to draw out cash in a financial agency.

Now, an operation of the present embodiment will be described below.

(I) In the case of using in first radio system for high frequency band:

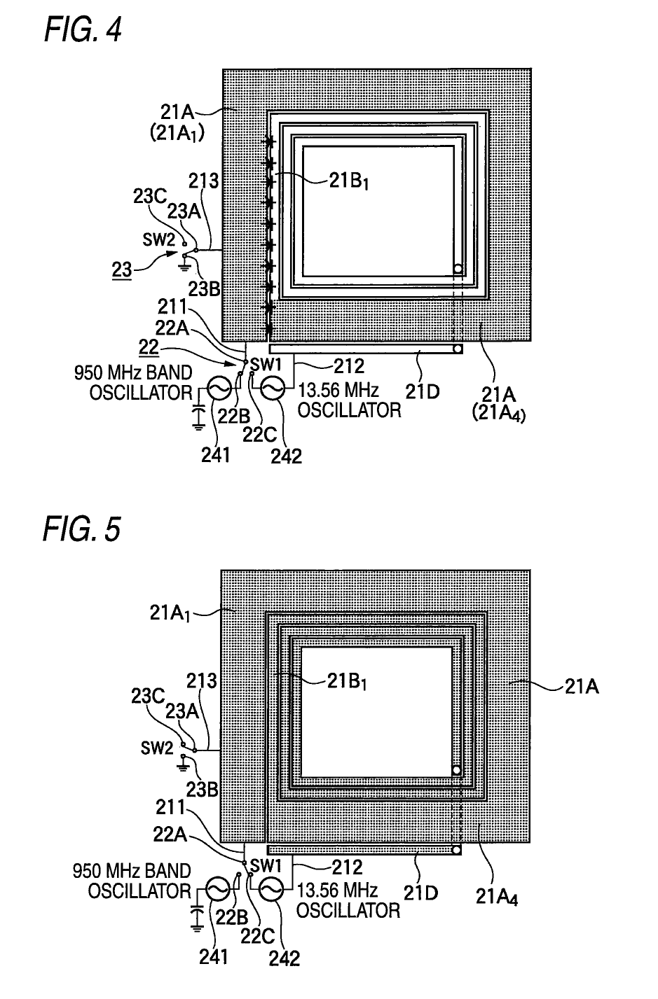

The user operates the switch 14 (see FIG. 1) for switching on/off to set the antenna to the radio system for, for instance, the RFID. Then, as shown in FIG. 4, the first switch SW1 operates in accordance with a control signal form the control part not shown in the drawing to connect the switching terminal 22A to the first feeding terminal 22B, and the second switch SW2 operates at the same time to connect the switching terminal 23A to the grounding terminal 23B. Thus, the spiral antenna is connected to the first feeding part 241 of a 950 MHz band to feed an electric power. Here, capacities C_{A} of wirings between the outermost winding part 21A and the outermost winding part of the inner peripheral winding part 21B are connected together in view of a distribution factor. Namely, in this frequency band, a conductor part (refer it to as an outermost side part 21B₁, hereinafter) of an outermost side as a starting part of the inner peripheral winding part 21B connected to one side part (refer it to as a fourth side part 21A₄, hereinafter) having an end point of the outermost winding part 21A is electrically conducted, in view of a high frequency current, to one side part (refer it to as a first side part 21A₁, hereinafter) having the starting point of the outermost winding part 21A of the spiral antenna 21. Accordingly, only the entire part of the outermost winding part 21A has the same potential and operates as the inverted F antenna shown in FIG. 3. In this case, the outermost winding part 21A forms the main body part M of the inverted F antenna A, the lead-out line 213 forms the short-circuit line S and the lead-out line 211 forms the feeding line P.

(II) In the case of using in second radio system for low frequency band:

The user operates the switch 14 for switching on/off to set the antenna to the radio system for, for instance, the FeliCa. Then, as shown in FIG. 5, the first switch SW1 operates in accordance with a control signal from the control part to connect the switching terminal 22A to the second feeding terminal 22C. On the other hand, the second switch SW2 operates to connect the switching terminal 23A to the opening terminal 23C. Thus, the first side part 21A₁ is physically connected to the end conductor part 21D and connected to the second feeding part 242 of 13.56 MHz to feed an electric power. In this frequency band, since capacities C_{A} between wirings of the spiral antenna 21 are low, adjacent peripheries are not electrically conducted together in view of a high frequency, but an electric current is supplied on the conductor from the outermost winding part 21A to the outermost winding part 21A and the end conductor part 21D in an ordinary wiring. Thus, the spiral antenna operates as the loop antenna F.

### Second Embodiment

Now, a second antenna device 3 according to a second embodiment of the present invention will be described below. In this embodiment, the same parts as those of the first embodiment are designated by the same reference numerals and a duplicated explanation thereof is avoided.

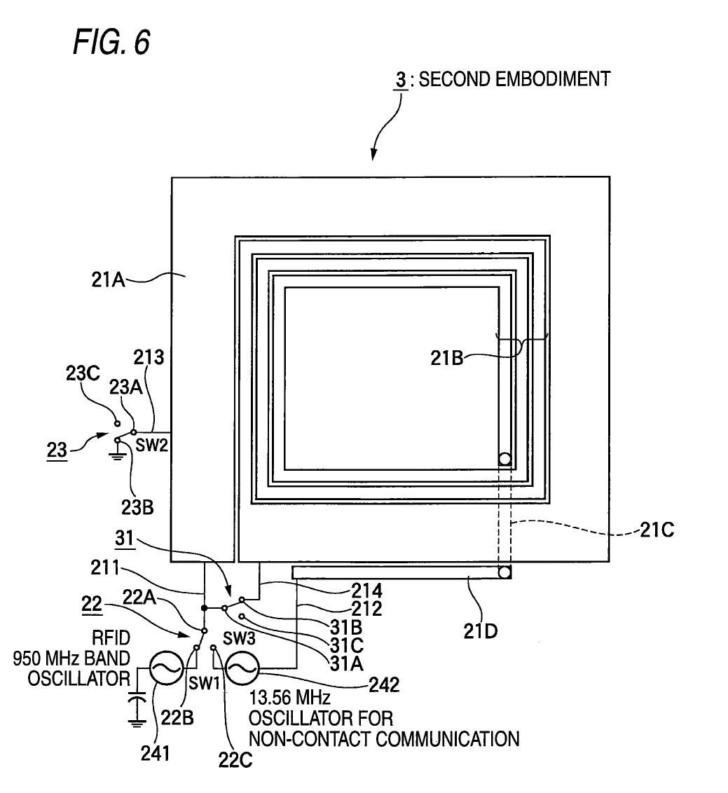

The second antenna device 3 of the present embodiment, which is different from the first embodiment, includes, as a radio switch unit, a third switch 31 (SW3) is provided as well as first and second switches between a starting point of an outermost winding part 21A of a spiral antenna 21 and an end point of the outermost winding part 21A, specifically described, a fourth side part 21A₄ of the outermost winding part 21A connected to an outermost side part 21B₁ of an inner peripheral winding part 21B as shown in FIG. 6.

The third switch SW3 switches and connects a second switching terminal 31A branching and provided from an intermediate part of a lead-out line 211 (a feeding line P) led out or drawn out from the starting point of the outermost winding part 21A either to a second switching terminal 31B or a fourth switching terminal 31C for opening provided in a lead-out line 214 led out or drawn out from an end point of an outermost peripheral side (that is, the fourth side part 21A₄) bent toward an inner periphery of the inner peripheral winding part 21B.

In the present embodiment, with such a structure, that is, the three switches SW1 to SW3 are operated, so that the spiral antenna may be switched to the spiral loop antenna 21 and a plate shaped antenna using an outermost periphery (the outermost winding part 21A).

Now, an operation of the present embodiment will be described below.

(I) In the case of using in first radio system for high frequency band:

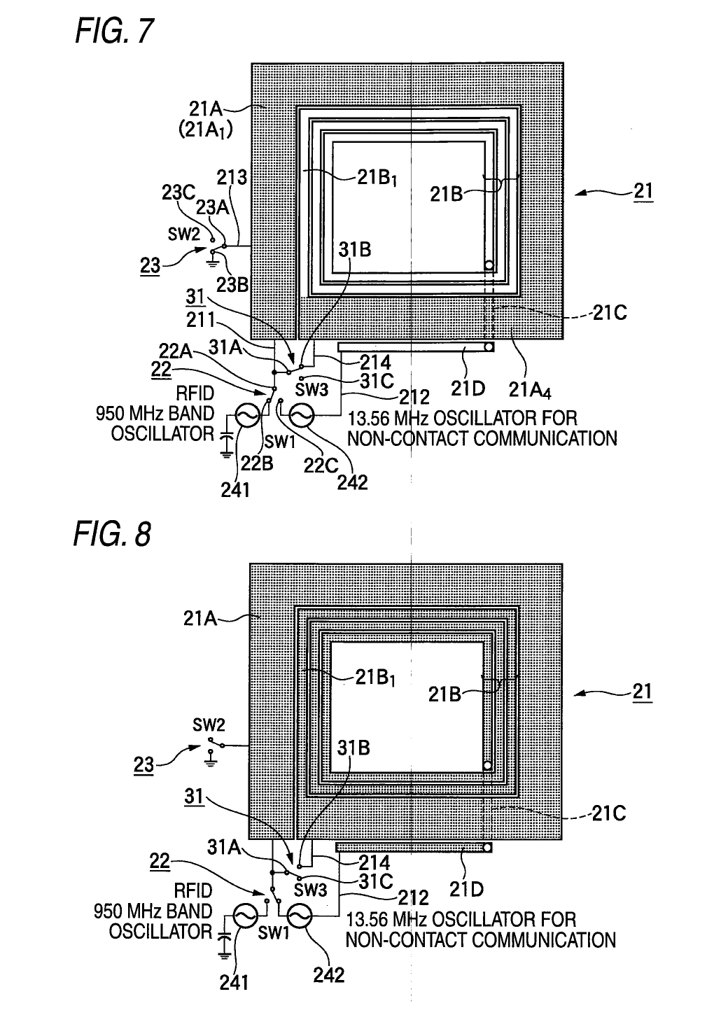

A user operates a switch 14 (see FIG. 1) for switching on/off to set the antenna to a communication system for, for instance, an RFID. Then, as shown in FIG. 7, the first switch SW1 operates in accordance with a control signal form a control part not shown in the drawing to connect a switching terminal 22A to a first feeding terminal 22B, and the second switch SW2 operates at the same time to connect a switching terminal 23A to a grounding terminal 23B. Further, the third switch SW3 operates at the same time as that of the switching operations to connect the second switching terminal 31A to the third switching terminal 31B.

In such a way, in a 950 MHz band, when the second switching terminal 31A is connected to the third switching terminal 31B, the first side part 21A₁ of the outermost winding part 21A is physically connected to the fourth side part 21A₄, an entire part of the outermost winding part 21A has the same potential and operates as an inverted F antenna. Further, a first feeding part 241 is connected to the spiral antenna 21 to feed an electric power thereto, however, in the 950 MHz band, since an impedance of the inner peripheral winding part 21B of a small width is high, an electric current is not supplied to the inner peripheral winding part 21B. Thus, a high frequency current is supplied only to the outermost winding part 21A. Accordingly, the outermost winding part 21A functions as the inverted F antenna including the outermost winding part 21A as a main body part M, a lead-out line 213 as a short-circuit line S and the lead-out line 211 as a feeding line P.

(II) In the case of using in second radio system for low frequency band:

The user operates the switch 14 for switching on/off to set the antenna to a communication system for, for instance, an FeliCa. Then, as shown in FIG. 8, the first switch SW1 operates in accordance with a control signal from the control part to connect the switching terminal 22A to a second feeding terminal 22C. On the other hand, the second switch SW2 operates to connect the switching terminal 23A to an opening terminal 23C. Further, the third switch SW3 operates at the same time as that of the switching operations to connect the second switching terminal 31A to the fourth switching terminal 31C.

In such a way, in a 13.56 MHz band as a low frequency band, when the second switching terminal 31A is connected to the fourth switching terminal 31C, the outermost winding part 21A is physically connected to the inner peripheral winding part 21B and an end conductor part 21D. Further, in this frequency band, a frequency is lower than that of the first radio system as in the first embodiment. Accordingly, since adjacent peripheries are not electrically conducted together in view of a high frequency, but the electric current is supplied to an actual conductor, the spiral antenna 21 operates as the loop antenna.

### Third Embodiment

Now, a third antenna device 4 according to a third embodiment of the present invention will be described below. In this embodiment, the same parts as those of the first embodiment are designated by the same reference numerals and a duplicated explanation thereof is avoided.

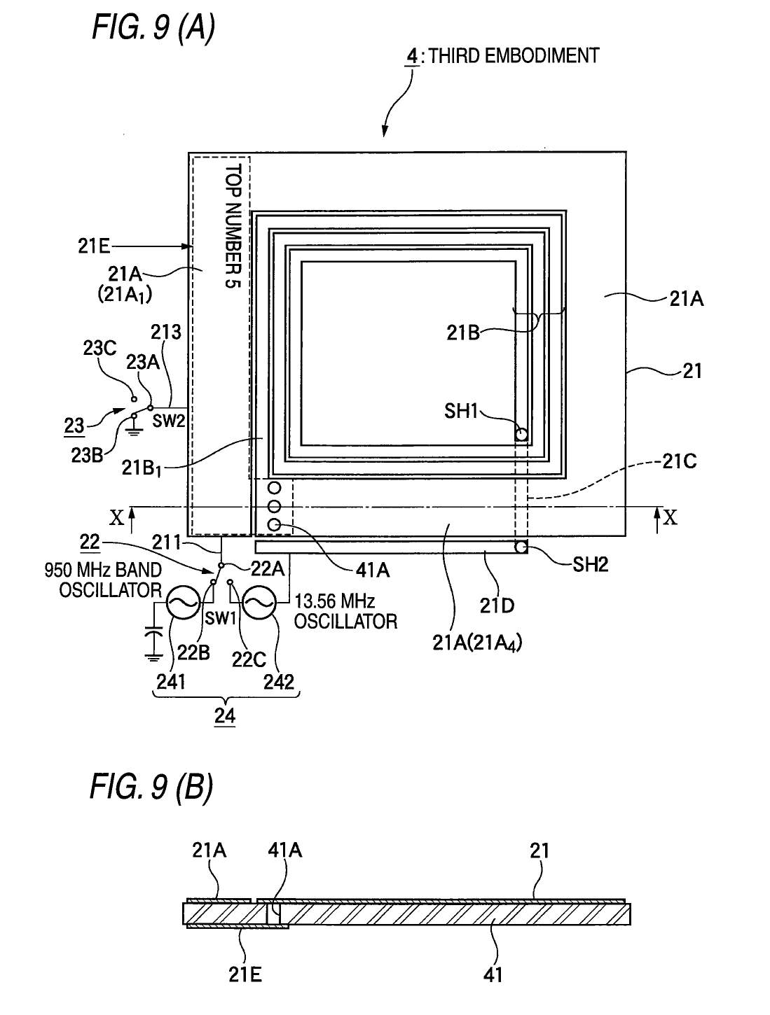

The third antenna device 4 of the present embodiment, which is different from the first embodiment, includes, as shown in FIG. 9, a conductor 21E that is formed on a lower surface of a board 41 having an upper surface on which a spiral antenna 21 is mounted and is electrically connected to a part of a fourth side part 21A₄ of an outermost winding part 21A through a through hole 41A.

The conductor 21E is formed substantially in an L shape (a part surrounded in a dotted line in the left side in FIG. 9(A)) and formed substantially in the same configurations as those of the first side part 21A₁ of the outermost winding part 21A and a part of the fourth side part 21A₄ as an end point of the outermost winding part 21A under a state that the conductor 21E is overlapped on them immediately below an outermost side part 21B₁ as a staring part of an inner peripheral winding part 21B connected to the fourth side part 21A₄

Now, an operation of the present embodiment will be described below.

(I) In the case of using in first radio system for high frequency band:

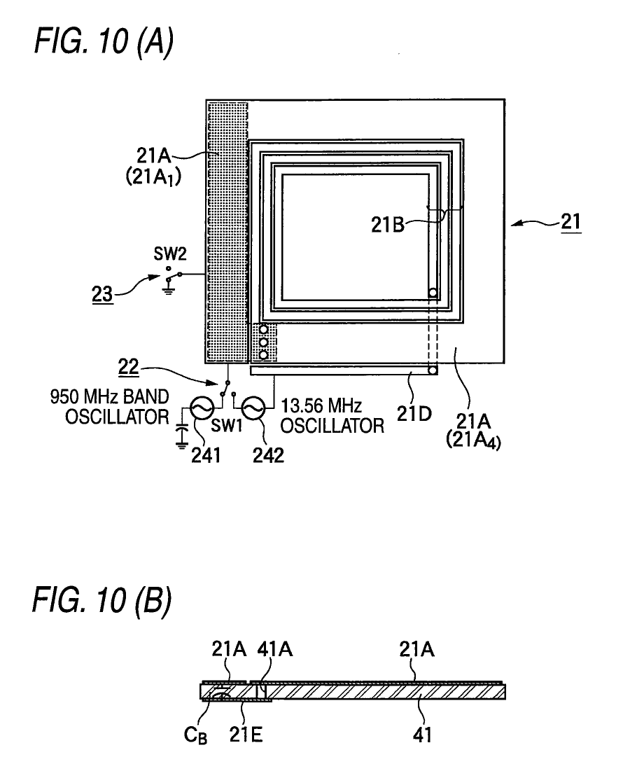

A user operates a switch 14 (see FIG. 1) for switching on/off to set the antenna to a communication system for, for instance, an RFID. Thus, as shown in FIG. 10, the outermost winding part 21A is connected to a first feeding part 241 of a 950 MHz band to feed an electric power thereto. Here, the conductor 21E may be electro-statically connected to the first side part 21A₁, a part of the fourth side part 21A₄ and the outermost side part 21B₁ by capacities C_{B} of wirings between the overlapped parts (the first side part 21A₁, a part of the fourth side part 21A₄ and the outermost side part 21B₁ and the conductor 21E) and has the same potential as those of them. That is, an entire part of the outermost winding part 21A has the same potential as that of the conductor 21E and operates as an inverted F antenna.

In the case of the present embodiment, a part corresponding to the main body part M of the inverted F antenna shown in FIG. 3 is substantially extended more by the conductor 21E than that of the first embodiment. Accordingly, since a connected capacity may be increased more than that of the first embodiment, a resonance frequency is low and a frequency band is narrowed.

(II) In the case of using in second radio system for low frequency band:

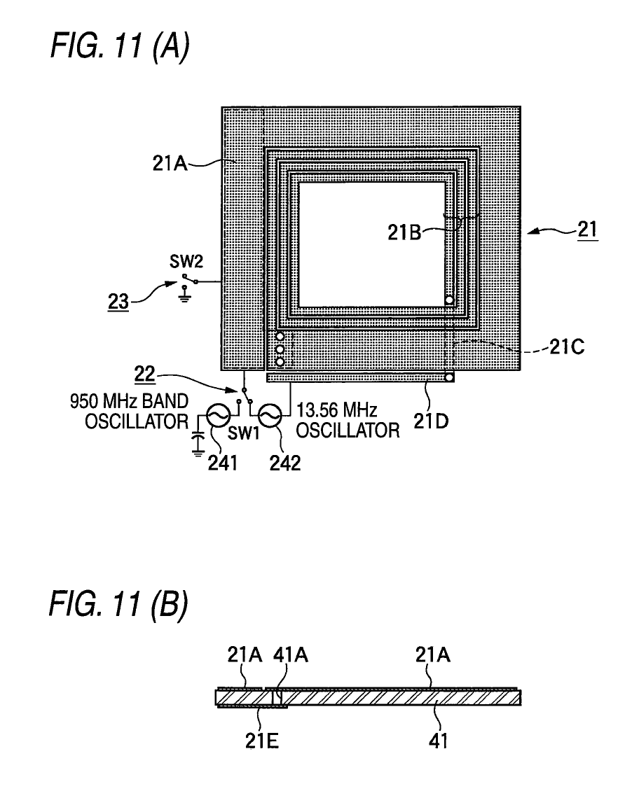

A user operates a switch 14 for switching on/off to set the antenna to a communication system for, for instance, an FeliCa. Thus, as shown in FIG. 11, the outermost winding part 21A is connected to a second feeding part 242 of 13.56 MHz band to feed an electric power thereto. In this case, in FIG. 11, the overlapped parts (the first side part 21A₁, a part of the fourth side part 21A₄ and the outermost side part 21B₁ and the conductor 21E) have the same potential. On the other hand, since the outermost winding part 21A is physically connected to the inner peripheral winding part 21B by a second switch SW2, a high frequency current is supplied between the outermost winding part 21A and the inner peripheral winding part 21B. Here, in a pattern of the conductor 21E, since an end face is opened, an electric current is not supplied to the conductor 21E. As a result, since the electric current is supplied only to a spiral conductor from the outermost winding part 21A to the inner peripheral winding part 21B and an end conductor part 21D of the spiral antenna 21, the spiral antenna 21 operates as the loop antenna F same as that of the first embodiment.

### Fourth Embodiment

Now, a fourth antenna device 5 according to a fourth embodiment of the present invention will be described below. In this embodiment, the same parts as those of the first embodiment are designated by the same reference numerals and a duplicated explanation thereof is avoided.

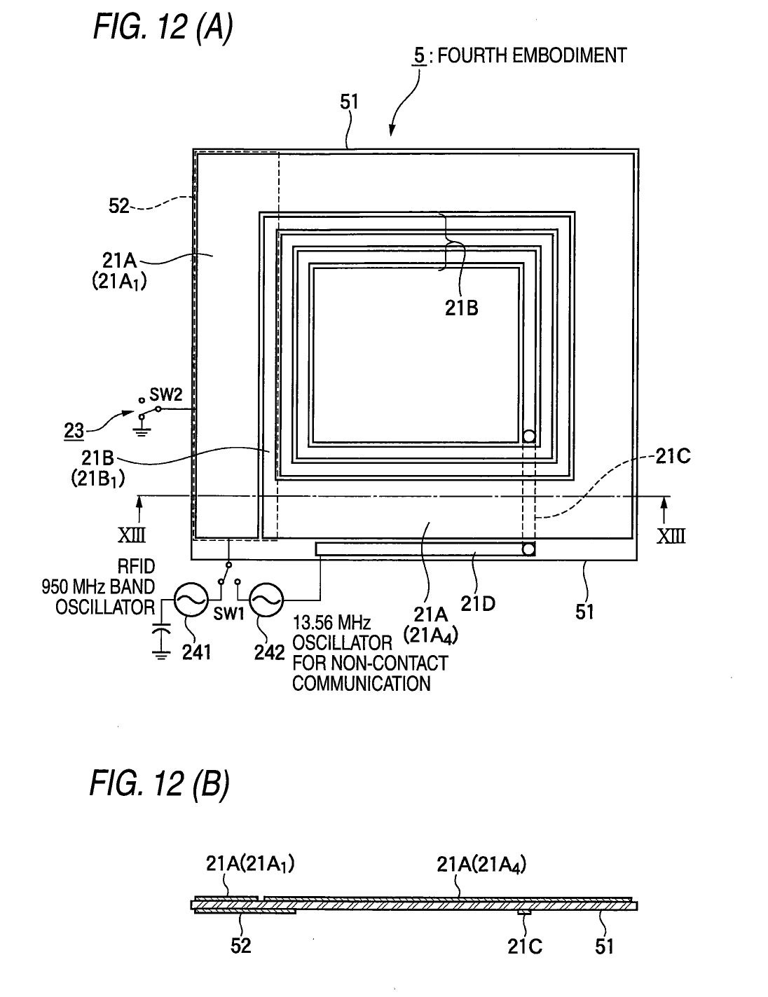

The fourth antenna device 5 of the present embodiment, which is different from the first embodiment, includes, as shown in FIG. 12, a metal conductor 52 on a back surface of an insulating board 51 having a surface on which a spiral antenna 21 is mounted.

The conductor 21F is formed substantially in the same configurations as those of a first side part 21A₁ of an outermost winding part 21A of the spiral antenna 21, a part of a fourth side part 21A₄ of the outermost winding part 21A and an outermost side part 21B₁ of an inner winding part 21B connected thereto under a state that the conductor 21F is overlapped on them immediately below them.

Now, an operation of the present embodiment will be described below.

(I) In the case of using in first radio system for high frequency band:

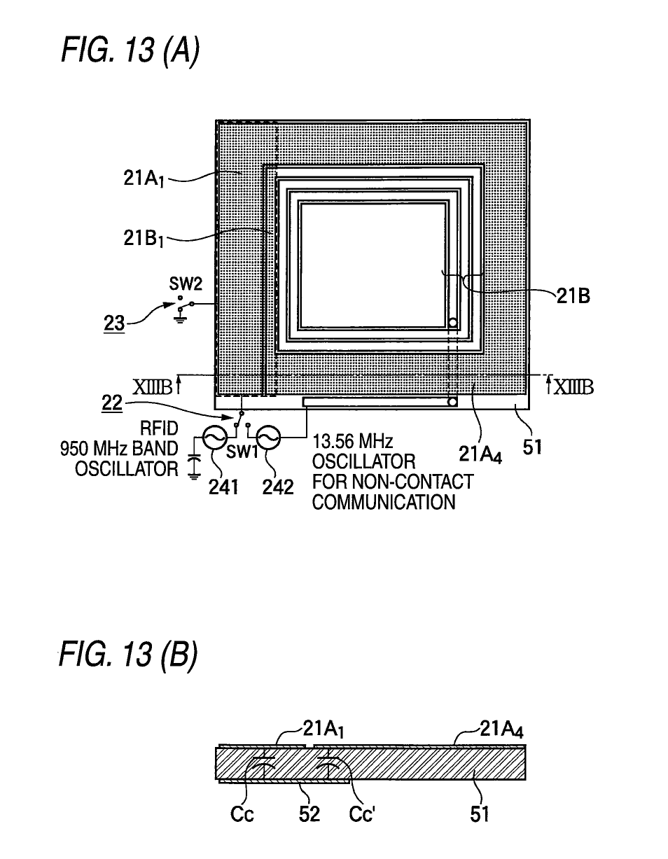

When a user operates a switch 14 (see FIG. 1) for switching on/off, the outermost winding part 21A is connected to a first feeding part 241 of a 950 MHz band to feed an electric power thereto. In this case, in FIG. 13, an entire part of the outermost winding part 21A has the same potential as that of the metal conductor 52 by a capacity connection Cc of the first side part 21A₁ (of the outermost winding part 21A) of the spiral antenna 21, a part of the fourth side part 21A₄ and the outermost side part 21B₁ (of the inner peripheral winding 21B) and the metal conductor 52 that is positionally overlapped on these conductors immediately below them through the insulating board 51 and operates as an inverted F antenna.

(II) In the case of using in second radio system for low frequency band:

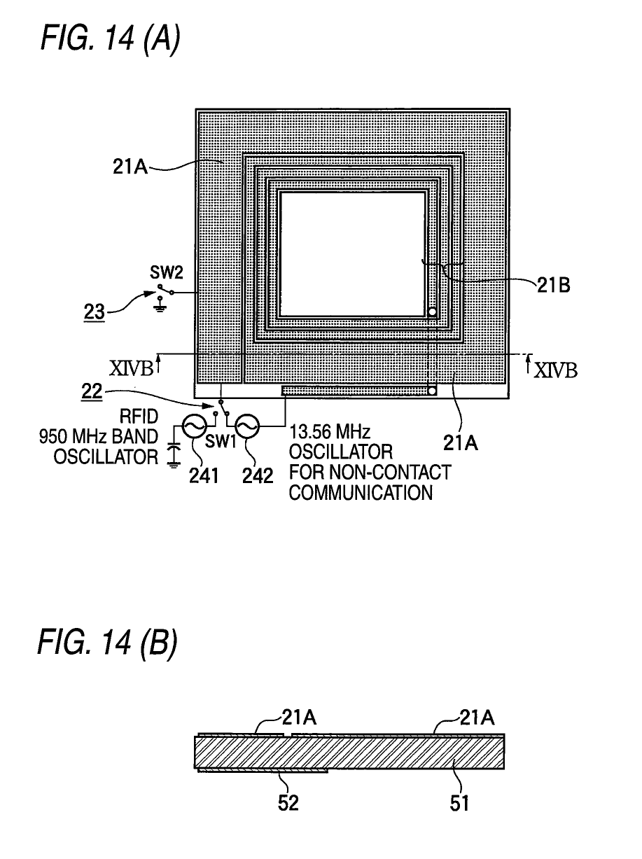

When a user operates a switch 14 for switching on/off to switch to an opposite part, the outermost winding part 21A is connected to a second feeding part 242 of 13.56 MHz band to feed an electric power thereto. In this case, in FIG. 14, the parts overlapped in upper and lower parts in view of a position (the outermost end conductor part 21A₁, a part of the fourth side part 21A₄ and the conductor 21B₁ and the metal conductor 52) have the same potential by an electrostatic connection. Further, since a first switch SW1 is switched by operating the switch 14, the outermost winding part 21A is physically connected to the inner peripheral winding part 21B. Accordingly, an ac current is supplied from the outermost winding part 21A to the inner peripheral winding part 21B. However, in a pattern of the metal conductor 52, since an end face is opened, an electric current is not supplied to the metal conductor 52. Namely, since the electric current is supplied only to a spiral conductor from the outermost winding part 21A to the inner peripheral winding part 21B and an end conductor part 21D of the spiral antenna 21, the spiral antenna 21 operates as the loop antenna F same as those of the first to third embodiments.

### Fifth Embodiment

Now, a fifth antenna device 6 according to a fifth embodiment of the present invention will be described below. In this embodiment, the same parts as those of the first embodiment are designated by the same reference numerals and a duplicated explanation thereof is avoided.

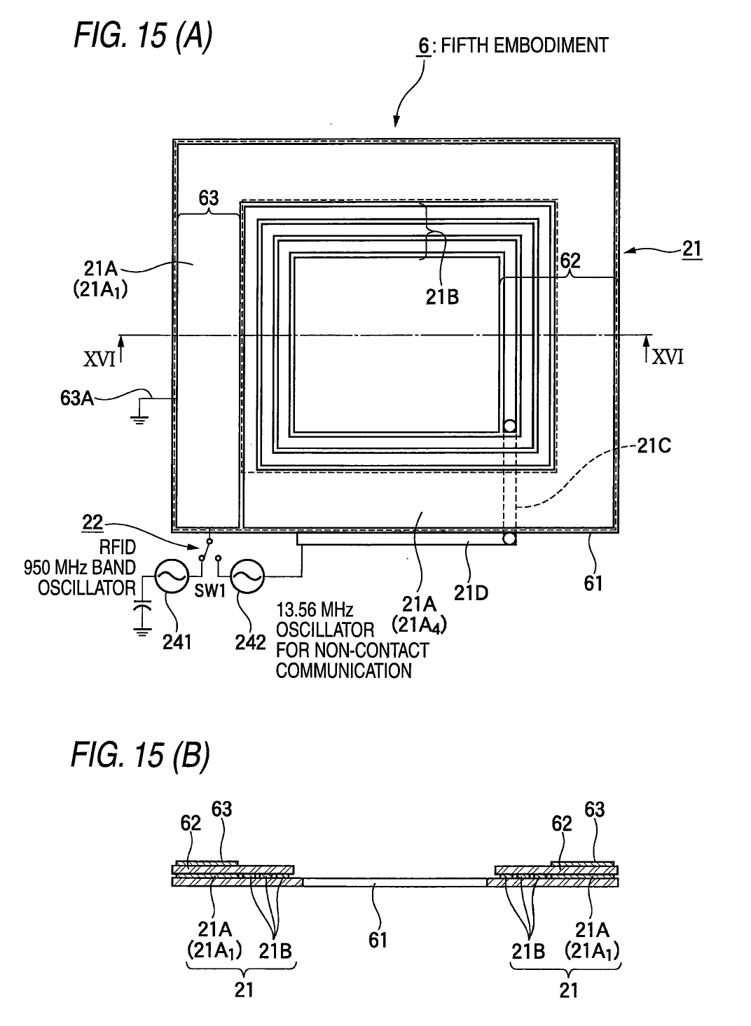

In the fifth antenna device 6 of the present embodiment, as shown in FIG. 15, a spiral antenna 21 the same as that of the first embodiment is mounted on the surface of a board 61. An insulating board 62 formed substantially in the shape of a character [symbol] is laminated thereon in such a way as to cover the entire surface of the spiral antenna 21. On the insulating board 62, a metal conductor 63 similarly formed substantially in the shape of a character [symbol] is mounted.

The metal conductor 63 having a width smaller than that of the insulating board 62 is laminated immediately above an outermost winding part 21A through the insulating board 62 so as to be overlapped on the outermost winding part 21A in view of a position. Further, in the metal conductor 63, since one end of a lead-out line 63A (a short-circuit line) led out or drawn out from a ground point necessary for an inverted F antenna is connected to a ground plate (GND of a casing side) not shown in the drawing, a second switch SW2 does not need to be provided as a grounding switch unit.

Now, an operation of the present embodiment will be described below.

(I) In the case of using in first radio system for high frequency band:

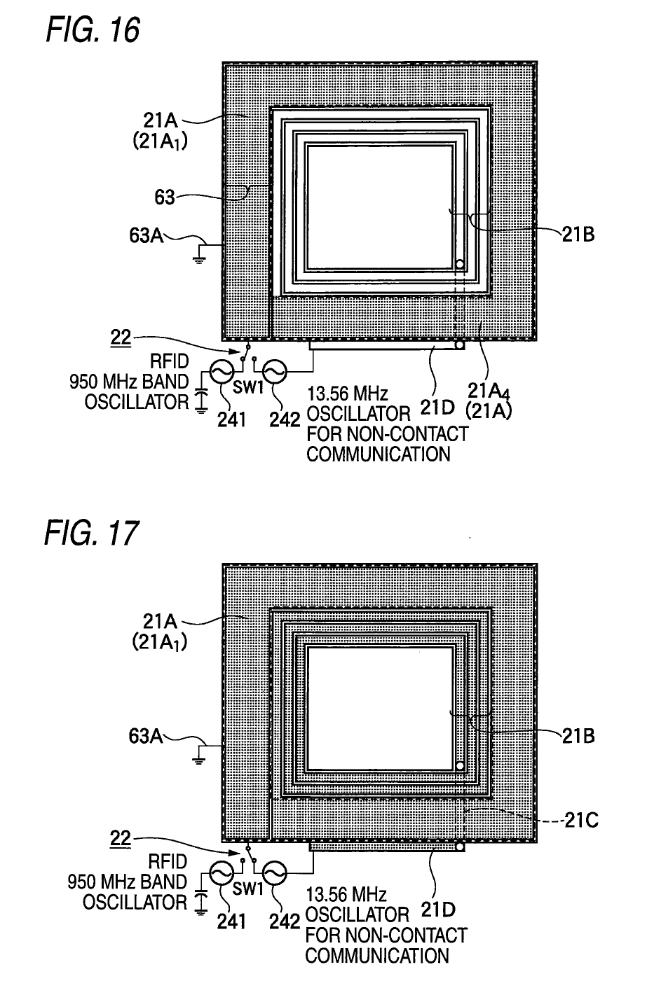

When a user operates a switch 14 (see FIG. 1) for switching on/off, the outermost winding part 21A is connected to a first feeding part 241 of a 950 MHz band to feed an electric power thereto. In this case, in FIG. 16, the outermost winding part 21A is electrically conducted to the metal conductor 63 in view of a high frequency to feed an electric power by a capacity connection of the outermost winding part 21A of the spiral antenna 21 and the metal conductor overlapped thereon positionally in upper and lower parts. In this case, since the metal conductor 63 is electrically conducted to the outermost winding part 21A1 in view of a high frequency, the two conductors form one antenna. Namely, the metal conductor 63 just above the outermost winding part 21A may receive the supply of a high frequency current from the first feeding part 241 through the outermost winding part 21A. Further, since a part corresponding to the ground point of the outermost winding part 21A is a ground part, the conductor part 63 may operate as an inverted F antenna.

(II) In the case of using in second radio system for low frequency band:

When a user operates a switch 14 for switching on/off to switch to an opposite part, as shown in FIG. 17, the outermost winding part 21A is connected to a second feeding part 242 of a 13.56 MHz band to feed an electric power thereto. In this low frequency band, since the capacity connection of the outermost winding part 21A of the spiral antenna 21 and the metal conductor 63 overlapped thereon positionally in upper and lower parts is low, an electric current is supplied to an ordinary wiring, that is, only to the spiral antenna 21 and the spiral antenna operates as a loop antenna. Namely, since a capacity is low between the metal conductor 63 and (the ground point thereof) is low, the metal conductor 63 is not electrically conducted thereto in view of a high frequency. Thus, the electric current is not supplied to the metal conductor 63.

### Sixth Embodiment

Now, a sixth antenna device 7 according to a sixth embodiment of the present invention will be described below. In this embodiment, the same parts as those of the first embodiment are designated by the same reference numerals and a duplicated explanation thereof is avoided.

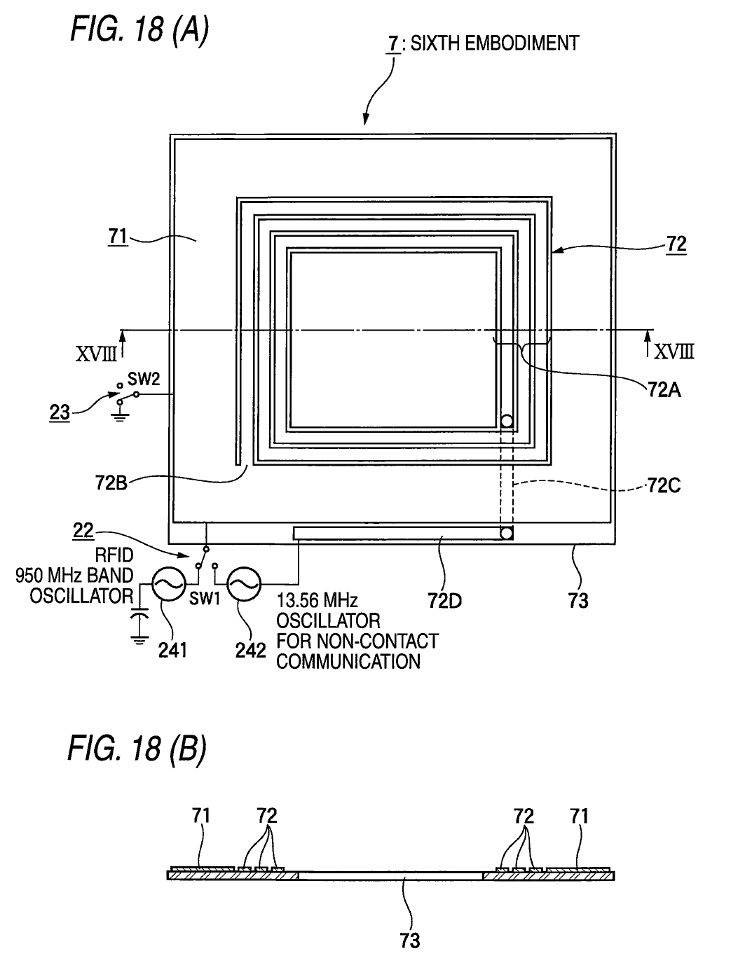

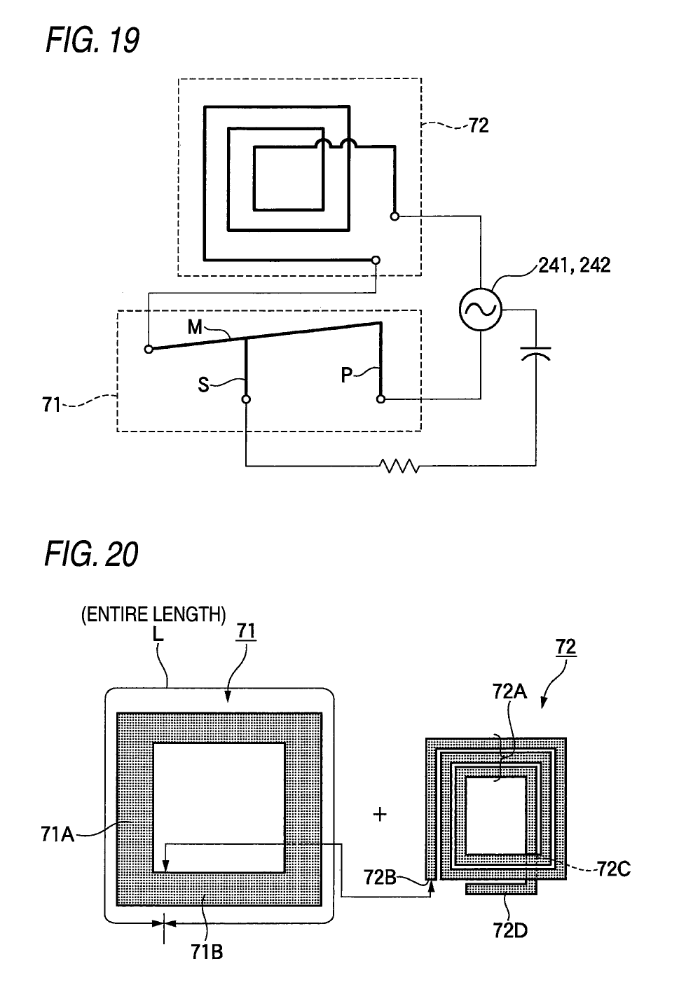

As shown in FIGS. 18 and 20, the sixth antenna device 7 of the present embodiment, which is different from the first embodiment, includes a metal conductor 71 having a plate shaped antenna part and a spiral antenna 72 having the same form as that of the inner peripheral winding part 21B of the first embodiment. The metal conductor 71 and the spiral antenna 72 are connected in parallel with a first feeding part 241 and a second feeding part 242 through a first switch SW1 forming a part of a feeding part switch unit 22 (see FIG. 19). The metal conductor 71 and the spiral antenna 72 are mounted on one surface of an insulating board 73.

As shown in FIG. 20, the metal conductor 71 is arranged outside the spiral antenna 72 and is formed with a plate shaped metal conductor with a central part bored substantially in the shape of a character [symbol] (the central part is hollow) to form a plate shaped antenna. Further, the metal conductor 71 may be switched to a spiral loop antenna and the plate shaped antenna depending on an employed frequency by using the inductance of wiring directed toward an inner periphery.

The spiral antenna 72 has a spiral shape similar to that of the inner peripheral winding part 21B as shown in FIG. 20. An inner edge part of one side part 71B of the metal conductor 71 and an outer end part 72B of a winding part 72A are physically formed integrally on the same surface.

Now, an operation of the present embodiment will be described below.

(I) In the case of using in first radio system for high frequency band:

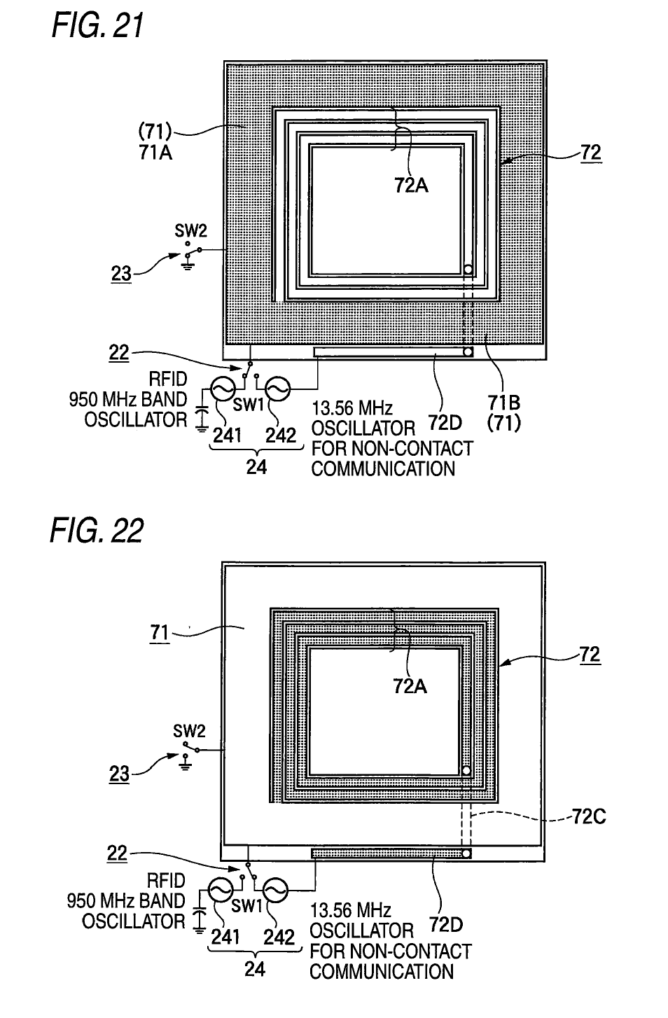

When a user operates a switch 14 (see FIG. 1) for switching on/off, the metal conductor 71 is connected to the first feeding part 241 of a 950 MHz band to feed an electric power thereto. In this high frequency band, in FIG. 21, an electric current is not supplied to an inner periphery (an inner peripheral winding part 72) of the spiral antenna 72 due to the high inductance component of a spiral loop, but is supplied only to the metal conductor 71. Thus, the metal conductor has a structure that may operate as an inverted F antenna.

(II) In the case of using in second radio system for low frequency band:

When a user operates a switch 14 for switching on/off to switch to an opposite part, as shown in FIG. 22, the metal conductor 71 is connected to the second feeding part 242 of a 13.56 MHz band to feed an electric power thereto. In this low frequency band, since the metal conductor 71 located at an outermost periphery has an entire length of a circumference (=length of four sides of the metal conductor 71) L smaller than the length (about 20 m) of a wavelength λ (=v/f; in this case, f=13.56 MHz, v=propagation velocity of radio wave), a high frequency current is not supplied. Namely, the electric current is supplied only to the spiral antenna 72 and the spiral antenna operates as the loop antenna. Further, since a capacity is low, the electric current is not supplied to the ground point of the metal conductor 71.

The present invention is not limited to the above-described embodiments and various forms may be embodied within a scope without departing from the gist of the invention.

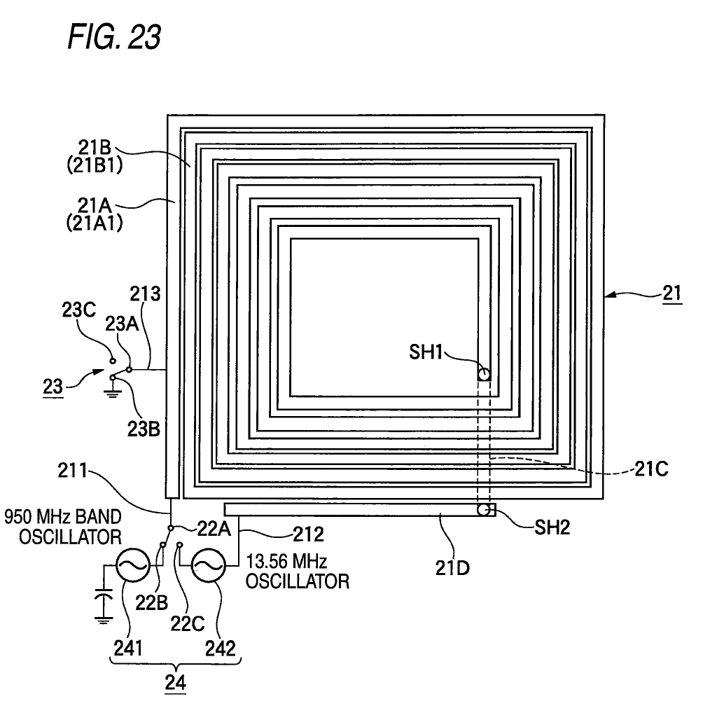

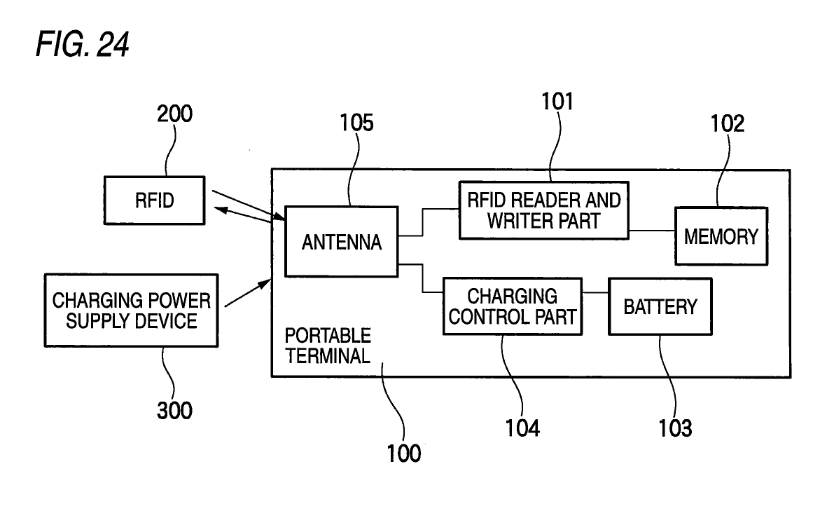

For instance, in place of a form in which the outermost winding part 21A1 is thickened in the first embodiment, as shown in FIG. 23, a structure may be formed in which spaces between wirings of an inner side part continuous to an outermost side part 21B1 are made to be dense to use an electrostatic connection between them. An operational principle in this case utilizes a capacity between wirings as in the first embodiment.

Further, a portable terminal device having the antenna device according to the embodiment of the present invention is not especially limited to the portable telephone described in the embodiments, and, for instance, such a structure as to mounted on a PHS or a PDA may be used. Further, an exclusive device of a handy type reader and writer may be used.

The present invention is specifically described above by referring to the specific embodiments, however, it is to be understood to a person with ordinary skill in the art that various changes and modifications may be made without departing from the spirit and scope of the present invention.

### INDUSTRIAL APPLICABILITY

The antenna device of the present invention can be effectively used for the radio communication systems of two different frequency bands by sharing a single antenna. The antenna device may be applied to the portable telephone, the PHS (Personal Handy-phone System), the PDA (Personal Digital Assistant) or the like as the portable terminal device and advantageously mounted thereon.

1. An antenna device comprising:
a spiral antenna formed in a spiral shape;
a first feeding part connected to and feeding an electric power to a first radio system operating in a first frequency band; and
a second feeding part connected to and feeding an electric power to a second radio system operating in a second frequency band, the antenna device including:
a feeding part switch unit that switches a connecting state of the first feeding part or the second feeding part and an outermost periphery or an inner periphery inside the outermost periphery of the spiral antenna, and
a grounding switch unit that switches a prescribed point of the outermost periphery of the spiral antenna to either an opening or a grounding, wherein the spiral antenna is formed in such a way that the width of a conductor forming the spiral antenna is different in its dimension between the outermost periphery and the inner periphery inside the outermost periphery.

2. The antenna device according to claim 1, wherein the feeding part switch unit is formed with a first switch that selectively connects the first feeding part or the second feeding part to a starting point of the outermost periphery of the spiral antenna or connects the first feeding part or the second feeding part to an end point of the inner periphery, and the first switch is operated so that the spiral antenna may operate as a spiral loop antenna or a plate shaped antenna using the outer periphery.

3. The antenna device according to claim 1, wherein the grounding switch unit is formed with a second switch that may switch the prescribed point of the outermost periphery of the spiral antenna either to an opening or a grounding, and the spiral antenna operates as the plate shaped antenna for a UHF band as a high frequency band or the spiral loop antenna for 13.56 MHz band as a low frequency band.

4. The antenna device according to claim 1, wherein the feeding part switch unit has the first switch that selectively connects the starting point of the outermost periphery of the spiral antenna to the first feeding part or the second feeding part and a third switch that selectively switches to connect the starting point of the outermost periphery of the spiral antenna to the end point of the outermost periphery or to open both the starting point and the end point of the outermost periphery of the spiral antenna, and when the starting point of the outermost periphery of the spiral antenna is connected to the radio system for the high frequency band of the first radio system or the second radio system by the first switch, the starting point of the outermost periphery of the spiral antenna is connected to the end point of the outermost periphery by the third switch, on the other hand, when the starting point of the outermost periphery of the spiral antenna is connected to the radio system for the low frequency band of the first radio system or the second radio system by the first switch, the starting point of the outermost periphery of the spiral antenna is opened to the end point of the outermost periphery of the spiral antenna by the third switch.

5. The antenna device according to claim 1, further comprising:
a plate shaped conductor positionally overlapped on an upper part or a lower part of the outer periphery of the spiral antenna with an insulating layer held between the conductor and the spiral antenna and having one end connected to the end point of the inner periphery of the spiral antenna, wherein the plate shaped conductor may be electro-statically connected to the outermost periphery, and the grounding switch unit and the feeding part switch unit are switched depending on a used communication system so that the spiral loop antenna and the plate shaped antenna using the outermost periphery may be switched.

6. The antenna device according to claim 1, wherein the plate shaped conductor is provided on the outermost periphery of the spiral antenna and a part of the inner periphery, the upper part or the lower periphery or both of them under a state the conductor is insulated from them, the outermost periphery of the spiral antenna and the inner periphery may be electro-statically connected to the conductor, and the grounding switch unit and the feeding part switch unit are switched depending on a used communication system so that the spiral loop antenna and the plate shaped antenna using the outermost periphery may be switched.

7. An antenna device comprising:
a spiral antenna formed in a spiral shape; and
a feeding part that feeds an electric power to the spiral antenna; the spiral antenna being formed with a conductor whose width is different in its dimension between an outermost periphery and an inner periphery inside the outermost periphery, the antenna device including:
a plate shaped metal conductor provided on an upper part or a lower part of the spiral antenna, insulated from them and formed substantially in the shape of a character [symbol] with a center bored; the metal conductor being formed to be electro-statically connected to the spiral antenna, the outermost periphery of the spiral antenna or the metal conductor being grounded at a prescribed point, and
a feeding part switch unit that switched a connecting state between the feeding part and the outermost periphery or the inner periphery of the spiral antenna, wherein the feeding part switch unit is switched depending on a used communication system so that the spiral antenna may be switched as an antenna of different frequency bands.

8. An antenna device comprising:
a spiral antenna formed in a spiral shape; and
a feeding part that feeds an electric power to the spiral antenna; the spiral antenna being formed with a conductor whose width is different in its dimension between an outermost periphery and an inner periphery inside the outermost periphery, the antenna device including:
a plate shaped metal conductor with a central part bored which is provided outside the spiral antenna under a state that the conductor is connected integrally in parallel with the spiral antenna;
a grounding switch unit that may switch a prescribed point of the outermost periphery of the spiral antenna to either an opening or a grounding; and
a feeding part switch unit that switches a connecting state between the feeding part and the outermost periphery or the inner periphery of the spiral antenna, wherein the feeding part switch unit is switched depending on a used communication system so that the spiral antenna may be switched and used as an antenna of different frequency bands by using the inductance of the inner periphery of the spiral antenna.

9. A portable terminal device having the antenna device according to any one of claims 1 to 8.
